(19) United States
(12) Patent Application Publication
(10) Pub. No.: US 2025/0393071 A1
(43) Pub. Date: Dec. 25, 2025

(54) TRANSMISSION STATION, AND TRANSMISSION METHOD

(71) Applicant: NIPPON TELEGRAPH AND TELEPHONE CORPORATION, Tokyo (JP)

(72) Inventors: Akira KISHIDA, Musashino-shi (JP); Junichi IWATANI, Musashino-shi (JP); Shinya OTSUKI, Musashino-shi (JP); Riku OMIYA, Musashino-shi (JP); Yusuke ASAI, Musashino-shi (JP); Yasushi TAKATORI, Musashino-shi (JP); Hirantha ABEYSEKERA, Musashino-shi (JP); Hanae OTANI, Musashino-shi (JP)

(73) Assignee: NIPPON TELEGRAPH AND TELEPHONE CORPORATION, Tokyo (JP)

(21) Appl. No.: 18/878,923

(22) PCT Filed: Jul. 5, 2022
(86) PCT No.: PCT/JP2022/026723

§ 371 Date: Dec. 26, 2024

(51) Int. Cl. H04W 74/0816; H04W 76/15

(52) U.S. Cl. CPC H04W 74/0816; H04W 76/15

(57) ABSTRACT

A transmission station includes a first transmission unit, a second transmission unit, and a management unit. The management unit is configured establish, with a reception station, a multilink in which first channel is allocated to the first transmission unit and a second channel is allocated to the second transmission unit. The second transmission unit is configured to start carrier sense processing regarding second data during an occupancy period in which the first transmission unit transmits first data, and transmit the second data subsequent to the first data in a case where a transmission right is acquired by the carrier sense processing.

### TECHNICAL FIELD

Embodiments relate to a transmission station and a transmission method.

### BACKGROUND ART

A wireless local area network (LAN) is known as a system that wirelessly connects an access point and a terminal apparatus to each other. The access point and the terminal apparatus in the wireless LAN perform carrier sense processing based on carrier sense multiple access with collision avoidance (CSMA/CA); and exchange traffic in a case where a transmission right is acquired.

### CITATION LIST

### Non Patent Literature

Non Patent Literature 1: EEE P802.11beTM/D1.5, “35.3.17 Enhanced multi-link single radio operation”, Mar. 18, 2022

### SUMMARY OF INVENTION

### Technical Problem

When traffic is exchanged, it is desirable to perform transmission control so that a specific link is not occupied for a long period of time.

The present invention has been made in view of the above circumstances, thereof is to provide a wireless communication environment in which traffic can be exchanged so that a specific link is not occupied for a long period of time.

### Solution to Problem

A transmission station of an aspect includes a first transmission unit, second transmission unit, and a management unit. The management unit is configured to establish, with a reception station, a multilink in which a first channel is allocated to the first transmission unit and a second channel is allocated to the second transmission unit. The second unit is configured to start carrier sense processing regarding second data during an occupancy period in which the first transmission unit transmits first data, and transmit the second data subsequent to the first data in a case where a transmission right is acquired by the carrier sense processing.

### Advantageous Effects of Invention

According to an embodiment, it is possible to provide a wireless communication environment in which traffic can be exchanged so that a specific link is not occupied for a long period of time.

### BRIEF DESCRIPTION OF DRAWINGS

FIG. 1 is a block diagram illustrating configuration of a communication system according to a first embodiment.

FIG. 2 is a diagram illustrating an example of link management information of the communication system according to the first embodiment.

FIG. 3 is a block diagram illustrating an example of a hardware configuration of an access point according to the fix embodiment.

FIG. 4 a block diagram illustrating an example of a hardware configuration terminal apparatus according to the first embodiment.

FIG. 5 is a block diagram illustrating an example of a functional configuration of the access point according to the first embodiment.

FIG. 6 is a block diagram illustrating an example of a functional configuration of the terminal apparatus according to the first embodiment.

FIG. 7 is a block diagram illustrating an example of a functional configuration regarding cascade transmission processing performed by a wireless signal processing unit according to the first embodiment.

FIG. 8 is a flowchart illustrating an example of the cascade transmission processing in the terminal apparatus according to the first embodiment.

FIG. 9 is a timing chart illustrating an example of the cascade transmission processing in the terminal apparatus according to first embodiment.

FIG. 10 is a block diagram illustrating a configuration of a communication system according to a second embodiment.

FIG. 11 is a block diagram illustrating an example of a functional configuration of a terminal apparatus according to the second embodiment.

FIG. 12 is a block diagram illustrating an example of a functional configuration regarding cascade transmission processing performed by a wireless signal processing unit according to the second embodiment.

FIG. 13 is a flowchart illustrating an example of the cascade transmission processing in the terminal apparatus according the second embodiment.

FIG. 14 is a timing chart illustrating an example of the cascade transmission processing in the terminal apparatus according to the second embodiment.

FIG. 15 is a timing chart illustrating an example of cascade transmission processing in a terminal apparatus according to a modification.

### DESCRIPTION OF EMBODIMENTS

Hereinafter embodiment's will be described with reference to the drawings. Note that in the following description, components having the same functions and configurations will be denoted by common reference signs.

### 1. First Embodiment

### 1.1 Configuration

### 1.1.1 Communication System

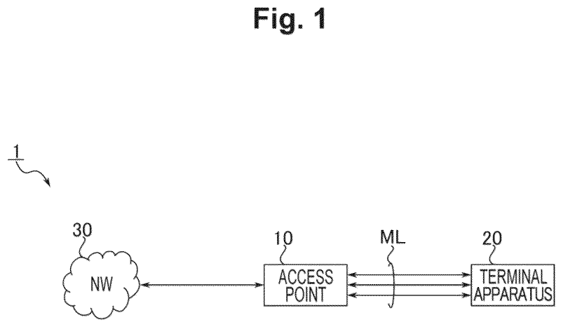

FIG. 1 is a block diagram illustrating an example of a configuration of a communication system according to a first embodiment. As illustrated in FIG. 1, a communication system 1 includes an access point 10, a terminal apparatus 20, and a network 30.

The access point 10 is, for example, a base station of a wireless LAN. The access point 10 is configured to communicate with a server (not illustrated) on the network 30 In a wired or wireless manner. The access point 10 is configured to communicate with the terminal apparatus 20 wirelessly. Communication between the access point 10 and the terminal apparatus 20 is based on, for example, the IEEE 802.11 standard.

The terminal apparatus 20 is, for example a wireless terminal apparatus such as a smartphone or a personal computer (PC). The terminal apparatus 20 is configured to communicate with the server on network 30 via the access point 10.

The access point 10 and the terminal apparatus 20 have, for example a wireless communication function based on an open systems interconnection (OSI) reference model. In the OSI reference model, the wireless connection function is divided into seven layers (the first layer: a physical layer, the second layer: a data link layer, the third layer: a network layer, the fourth layer: a transport layer, the fifth layer: a session layer, the sixth layer: a presentation layer, and the seventh layer: an application layer). The data link layer includes a logical link control (LLC) and a media access control (MAC) sublayer.

A multilink ML can be applied to a wireless connection method between the access point 10 and the terminal apparatus 20. The multilink ML is a wireless connection method capable of transmitting and receiving data (exchanging traffic) by simultaneously using a plurality of links. The access point 10 and the terminal apparatus 20 to which the multilink ML is applied manage a state of the multilink ML according to link management information.

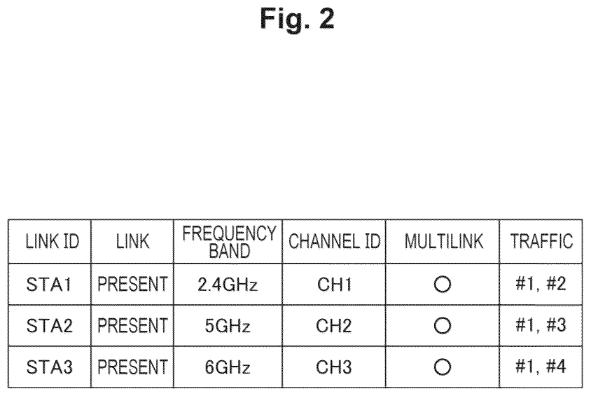

FIG. 2 is a diagram illustrating an example of the link management information of the communication system according to the first embodiment. The link management information includes, for example, information on each of “link ID”, “link”, “frequency band”, “channel ID”, “multilink”, and “traffic”.

The “link ID” is an identifier associated with an STA function. The STA function is a functional configuration provided in each of the access point 10 and the terminal apparatus 20 in order to establish a link between the access point 10 and the terminal apparatus 20. That is, a pair of STA functions is used for establishing one link. The example of FIG. 2 illustrates a case where three pairs of STA functions (STA1, STA2, and STA3) are allocated to wireless communication between the access point 10 and the terminal apparatus 20. The function corresponds to a wireless signal processing unit to be described later.

The “link” is information indicating whether or not a link is established between the access point 10 and the terminal apparatus 20 by the STA function. The example of FIG. 2 illustrates a case where all of STA1, STA2, and STA3 have established a link between the access point 10 and the terminal apparatus 20.

The “frequency band” information indicating frequency band used for a link. As the frequency band, for example, the 2.4 GHz band, the 5 GHz band, the 6 GHz band, and the like can be applied. Each frequency band includes a plurality of channels. The example of FIG. 2 illustrates a case where the 2.4 GHz band, the 5 GHz band, and the 6 GHz band are allocated to STA1, STA2, and STA3, respectively.

The “channel ID” is an identifier of a channel used for a link. The example of FIG. 2 illustrates a case where a channel CH1 of the 2.4 GHz band, a channel CH2 of the 5 GHz band, and a channel CH3 of the 6 GHz band are allocated to STA1, STA2, STA3, respectively.

The “multilink” is information indicating whether or not the access point 10 and the terminal apparatus 20 establish the multilink ML. The example of FIG. 2 illustrates a case where a set of STA1, STA2, and STA3 establishes the multilink ML.

The “traffic” is information indicating a traffic indicator (TID) allocated to an STA function. Each TID is an identifier indicating traffic, and may be associated with an access category. The access category of the traffic includes, for example, “voice (VO)”, “video (VI)”, “best effort (BE)”, “background (BK)”, and “low latency (LL)”. Each of TIDs #1 to #4 in FIG. 2 corresponds to, for example, any of the access categories VO, VI, BE, BK, and LL. The example of FIG. 2 illustrates case where a TID #1 is allocated to STA1, STA2, and STA3. In addition, a case is illustrated where TIDs #2, #3, and #4 further allocated STA1, STA2, and STA3, respectively. As described, in the multilink ML, one or a plurality of STA functions can be allocated to one TID.

### 1.1. Hardware Configuration

Next, harware configurations will be described of the access point and the terminal apparatus in the communication system according to the first embodiment.

### 1.1.2.1 Hardware Configuration of Access Point

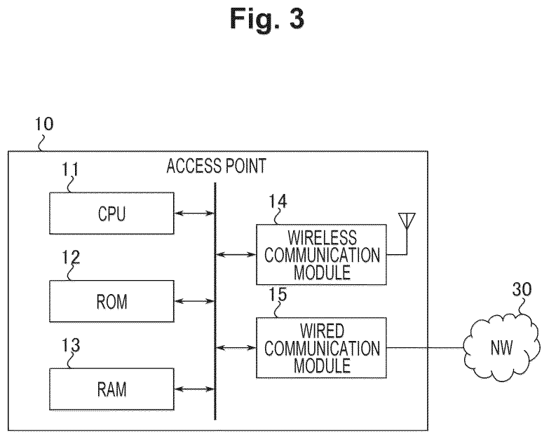

FIG. 3 is a block diagram illustrating an example of a hardware configuration of the access point according to the first embodiment. As illustrated n FIG. 3. the access point 10 includes, for example, a central processing unit (CPU) 11, read only memory (ROM) 12, random access memory (RAM) 13, a wireless communication module 14. and a wired communication module 15.

The CPU 11 is a processing circuit that controls entire operation of the access point 10. The ROM 12 is, for example, a nonvolatile semiconductor memory. The ROM 12 stores programs and data for controlling the access point 10. The RAM 13 is, for example, volatile semiconductor memory. The RAM 13 is used as a work area of the CPU 11. The communication module 14 is a circuit used to transmit and receive data by a wireless signal. The wireless communication module 14 is connected to an antenna. The wired communication module 15 is a circuit used to transmit and receive data by a wired signal. The wired communication module 15 is connected to the network 30.

### 1.1.2.2 Hardware Configuration of Terminal Apparatus

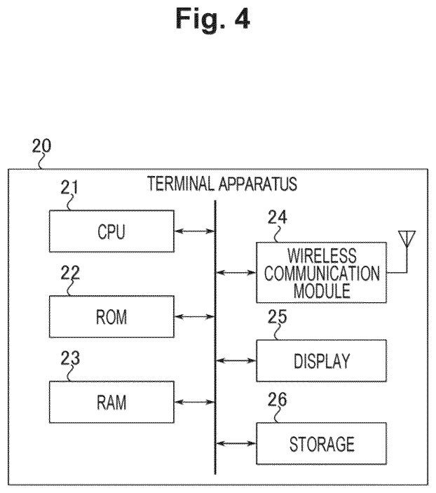

FIG. 4 is a block diagram illustrating an example of a hardware configuration of the terminal apparatus according to the first embodiment. As illustrated in FIG. 4, the terminal apparatus 20 includes, for example, a CPU 21, ROM 22, RAM 23, a wire communication module 24, a display 25, and a storage 26.

The CPU 21 is a processing circuit that controls entire operation of the terminal apparatus 20. The ROM 22 is, for example, a nonvolatile semiconductor memory. The ROM 22 stores programs and data for controlling the terminal apparatus 20. The RAM 23, for example, a volatile semiconductor memory. The RAM 23 is used as a work area of the CPU 21. The wireless communication module 24 is a circuit used to transmit and receive data by a wireless signal. The wireless communication module 24 is connected to an antenna. The display 25 is, for example, a liquid crystal display (LCD) or an electro-luminescence (EL) display. The display 25 displays graphical user interface (GUI) corresponding to application software, or the like. The storage 26 is a nonvolatile storage device. The storage 26 stores system software and the like of the terminal apparatus 20.

### 1.1.3 Functional Configuration

Next, functional configurations will be described of the access point and the terminal apparatus in the communication system according to the first embodiment.

### 1.1.3.1 Functional Configuration of Access Point

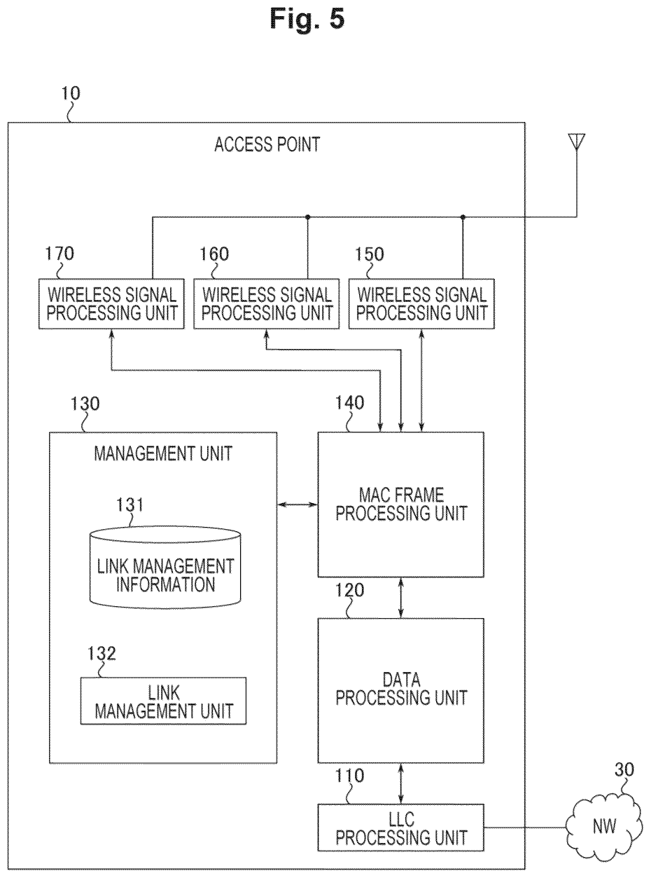

FIG. 5 is a block diagram illustrating example of the functional configuration of the access point according to the first embodiment.

The access point 10 functions as computer including an LLC processing unit 110, a data processing unit 120, a management unit 130, a MAC frame processing unit 140, and a plurality of wireless signal processing units 150, 160, and 170. The LLC processing unit 110 is a functional block that executes processing corresponding to the LLC sublayer of the second layer and the third layer to the seventh layer. The data processing unit 120, the management unit 130, and the MAC frame processing unit 140 are functional blocks that execute processing corresponding to the MAC sublayer of the second layer. The plurality of wireless signal processing units 150, 160, and 170 are functional blocks that execute processing corresponding to the MAC sublayer of the second layer and the first layer.

The LLC processing unit 110 adds, for example, a destination service access point (DSA) header, a source service access point (SSAP) header, and the like to data received from the network 30 to generate an LLC packet. Then, the LLC processing unit 110 inputs the generated LLC packet to the data processing unit 120. In addition, the LLC processing unit 110 extracts data from the LLC packet input from the data processing unit 120. Then, the LLC processing unit 110 transmits the extracted data to the network 30.

The data processing unit 120 adds a MAC header to the LLC packet input from the LLC processing unit 110 to generate a MAC frame. Then, the data processing unit 120 inputs the generated MAC frame to the processing unit 140. In addition, the data processing unit 120 extracts the LLC packet from the MAC frame input from the MAC frame processing unit 140. Then, the data processing unit 120 inputs the extracted LLC packet to the LLC processing unit 110. Hereinafter, a MAC frame including data is also referred to as a “data frame”.

The management unit 130 manages a state of a link between the access point 10 and the terminal apparatus 20. A MAC frame including management information regarding a link is input and output between the management unit 130 and the MAC frame processing unit 140, Hereinafter, a MAC frame including management information is also referred to as a “management frame”. The unit 130 includes link management information 131 and a link management unit 132.

The link management information 131 is information regarding a link between the access point 10 and the wirelessly connected terminal apparatus 20. The link management information 131 includes, for example, the information illustrated in FIG. 2.

The link management unit 132 controls establishment of a link with the terminal apparatus 20. For example, the link management unit 132 executes association processing and subsequent authentication processing in response to a connection request from the terminal apparatus 20. The link management unit 132 controls a state of a link established with terminal apparatus 20. For example, when establishing the multilink MD, the link management unit 132 can determine association between the TID and the STA function.

When a MAC frame is input from the data processing unit 120 or the management unit 130, the MAC frame processing unit 140 associates the MAC frame with a link. For example, in a case where a MAC frame is input from the data processing unit 120, the MAC frame processing unit 140 refers to the link management information 131 to specify a link associated with a TID included in the MAC header. Then, the MAC frame processing unit 140 inputs the MAC frame to a wireless signal processing unit corresponding to the specified link. In addition, when MAC frames are input from the plurality of wireless signal processing units 150, 160, and 170, the MAC frame processing unit 140 inputs the MAC frames to the data processing unit 120 or the management unit 130 according to types of the MAC frames. Specifically, in a case where a MAC frame is a data frame, the MAC frame processing unit 140 inputs the MAC frame to the data processing unit 120. In a case where a MAC frame is a management frame, the MAC frame processing unit 140 inputs the MAC frame to the management unit 130.

Note that, when a data frame is input from the data processing unit 120, the MAC frame processing unit 140 determines whether or not a frame size of the data frame is greater than equal to a threshold α. The threshold α is, for example, a positive real number. In a case where the frame size is greater than or equal to the threshold α, the MAC frame processing unit 140 performs fragment processing on the data frame to generate plurality of data frames each having a frame size smaller than the threshold α. The MAC frame processing unit 140 associates the generated plurality of data frames respectively with a plurality of links different from each other. Then, the MAC frame processing unit 140 inputs a corresponding data frame to the wireless signal processing unit corresponding to the specified link.

A transmission order k of the plurality of data frames generated by the fragment processing is associated with, for example, a fragment number FN. Hereinafter, for convenience of description, it is assumed that a data frame with the fragment number FN=k is transmitted kth. The transmission order k is an integer greater than or equal to 1 and less than or equal to kₘ. The integer kₘ is the number of data frames generated by the fragment processing.

The plurality of signal processing units 150, 160, and 170 correspond to STA1, STA2, and STA3 in the multilink ML illustrated in FIG. 2, respectively. Each of the plurality of wireless signal processing units 150, 160, and 170 has an equivalent functional configuration. Each of the plurality of wireless signal processing units 150, 160, and 170 generates a wireless frame by adding a preamble or the like to the MAC input from the MAC frame processing unit 140. Each of the plurality of wireless signal processing units 150, 160, and 170 converts the generated wireless into wireless signal. Then, each of the plurality of wireless signal processing units 150, 160, and 170 radiates (transmits) the converted wireless signal via the antenna. Conversion processing from the wireless frame to the wireless signal includes for example, convolutional encoding processing, interleaving processing, subcarrier modulation processing, inverse fast Fourier transform processing, orthogonal frequency division multiplexing (OFDM) modulation processing, and frequency conversion processing. In addition, each of the plurality of wireless signal processing units 150, 160, and 170 converts a wireless signal from the terminal apparatus 20 received via the antenna into a wireless frame. Conversion processing from the wireless signal to the wireless frame includes, for example, frequency conversion processing, OFDM demodulation processing fast Fourier transform processing, subcarrier demodulation processing, deinterleaving processing, and Viterbi decoding processing. Each of the plurality of wireless signal processing units 150, 160, and 170 extracts the MAC frame from the converted wireless frame. Then, each of the plurality of signal processing units 150, 160, and 170 inputs the extracted MAC frame to the MAC frame processing unit 140.

Note that, in a case where the plurality of data frames generated by the fragment processing are input, the plurality of wireless signal processing units 150, 160, and 170 execute cascade transmission processing in cooperation with each other The cascade transmission processing is processing of continuously transmitting the plurality of data frames subjected to the fragment processing. Details of the cascade transmission processing will be described later.

### 1.1.3.2 Functional Configuration of Terminal Apparatus

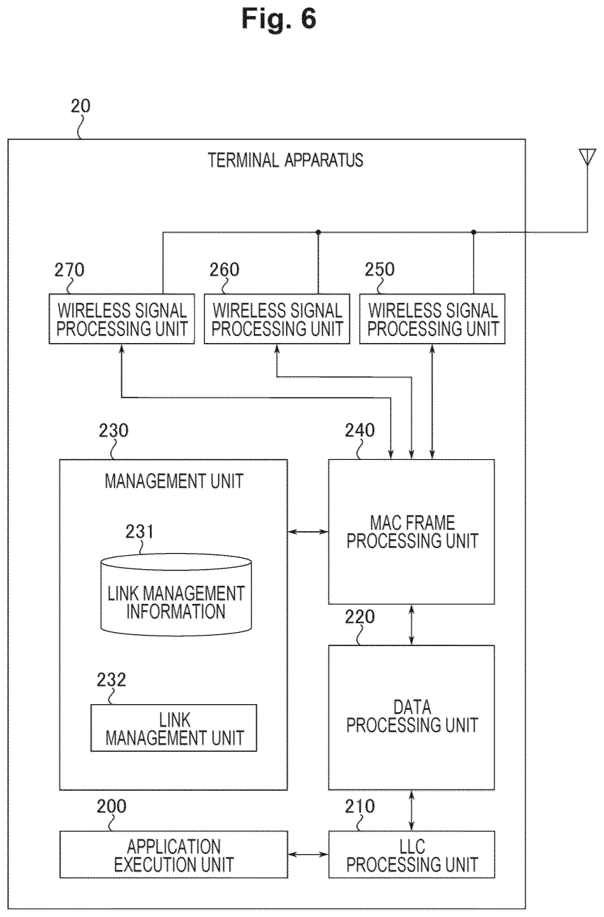

FIG. 6 is a block diagram illustrating an example of the functional configuration of the terminal apparatus according to the first embodiment.

The terminal apparatus 20 functions as a computer including an application unit 200, an LLC processing unit 210, a data processing unit 220, a management unit 230, a MAC frame processing unit 240, and a plurality of wireless signal processing units 250, 260, and 270. The application execution unit 200 is a functional block that executes processing corresponding to the seventh layer. The LLC processing unit 210 is a functional block that executes processing corresponding to the LLC sublayer of the second layer and the third layer to the sixth layer. The data processing unit 220, the management unit 230, and the MAC frame processing unit 240 are functional blocks that execute processing corresponding to the MAC sublayer of the second layer. The plurality of wireless signal processing units 250, 260, and 270 are functional blocks that execute processing corresponding to the MAC sublayer of the second layer and the first layer.

The application execution unit 200 executes an application on the basis of data input from the LLC processing unit 210. In addition, the application execution unit 200 inputs he LLC processing unit 210. For example, application execution unit 200 can display application information on the display 25. In addition, the application execution unit 200 can operate on the basis of operation on an input interface.

The LLC processing unit 210 adds a DSAP header, an SSAP header, and the like to data input from the application execution unit 200 to generate an LLC packet. Then, the LLC processing unit 210 inputs the generated LLC packet to the data processing unit 220. In addition, the LLC processing unit 210 extracts data from the LLC packet input from the data processing unit 220. Then, the LLC processing unit 210 inputs the extracted data to the application execution unit 200.

The data processing unit 220 adds a MAC header to the LLC packet input from the LLC processing unit 210 to generate a MAC frame. Then, the data processing unit 220 inputs the generated MAC frame to the MAC frame processing unit 240. In addition, the data processing unit 220 extracts the LLC packet from the MAC frame input from the MAC frame processing unit 240. Then, the data processing unit 220 inputs the extracted LLC packet to the LLC processing unit 210

The management unit 230 manages a state of a link between the access point 10 and the terminal apparatus 20. A MAC frame including management information regarding a link is input and output between the management unit 230 and the MAC frame processing unit 240. management unit 230 includes link management information 231 and a link management unit 232.

The link management information 231 is information regarding a link between he terminal apparatus 20 and the wirelessly connected access point 10. The link management information 231 includes, for example, the information illustrated in FIG. 2.

The link management unit 232 controls establishment of a link with the access point 10. For example, the link management unit 232 executes association processing and subsequent authentication processing when transmitting a connection request to the access point 10. The link management unit 232 controls a state of a link established with the access point 10. For example, when establishing the multilink ML, the link management 232 can determine association between the TID and the STA function.

When a MAC frame is input from the data processing unit 220 or the management unit 230, the MAC frame processing unit 240 associates the MAC frame with a link. For example, in a case where a MAC frame is input from the data processing unit 220, the MAC frame processing unit 240 refers to the link management information 231 to specify a link associated with a TID included in the MAC header. Then, the MAC frame processing unit 240 inputs the MAC frame to a wireless signal processing unit corresponding to the specified link. In addition, when MAC frames are input from the plurality of wireless processing units 250, 260, and 270, the MAC frame processing unit 240 inputs the MAC frames to the data processing unit 220 or the management unit 230 according to types of the MAC frames. Specifically, in a case where a MAC frame is a data frame, the MAC frame processing unit 240 inputs the MAC frame to the data processing unit 220. In a case where a MAC frame is a management frame, the MAC frame processing unit 240 inputs the MAC frame to the management unit 230.

Note that, when a data frame is input from the data processing unit 220, the MAC frame processing unit 240 determines whether or not a frame size of the data frame is greater than or equal to the threshold α. In a case where the frame size is greater than or equal to the threshold α, the MAC frame processing unit 240 performs fragment processing on the data frame to generate a plurality of data frames each having a frame size smaller than the threshold α. Then, the MAC frame processing unit 240 associates the generated plurality of data frames respectively with a plurality of links different from each other. Then, the MAC frame processing unit 240 inputs a corresponding data frame to the wireless signal processing unit corresponding to th specified link,

The plurality of wireless signal processing units 250, 260, and 270 correspond to STA1, STA2, and STA3 in the multilink ML illustrated in FIG. 2, respectively. Each of the plurality of wireless signal processing units 250, 260, and 270 has an equivalent functional configuration. Each of the plurality of wireless signal processing units 250, 260, and 270 generates a wireless frame by adding a preamble or the like to the MAC frame input from the MAC frame processing unit 240. Each of the plurality of wireless signal processing units 250, 260, and 270 converts the generated wireless frame into a wireless signal. Then each of the plurality of wireless signal processing units 250, 260, and 270 radiates (transmits) the converted wireless signal via the antenna. Conversion processing from the wireless frame to the wireless signal includes, for example, convolutional encoding processing, interleaving processing, subcarrier modulation processing, inverse fast Fourier transform processing, OFDM modulation processing, and frequency conversion processing. In addition, each of the plurality of wireless signal processing units 250, 260, and 270 converts a wireless signal from the access point 10 received via the antenna into a wireless frame. Conversion processing from the wireless signal to the wireless frame includes, for example, frequency conversion processing, OFDM demodulation processing, fast Fourier transform processing, subcarrier demodulation processing, deinterleaving processing, and Viterbi decoding processing. Each of the plurality of wireless signal processing units 250, 260, and 270 extracts the MAC frame from the converted wireless frame. Then, each of the plurality of wireless signal processing units 250, 260, and 270 inputs the extracted MAC frame to the MAC frame processing unit 240.

Note that, in a case where the plurality of data frames generated by the fragment processing are input, the plurality of wireless signal processing units 250, 260, and 270 execute cascade transmission processing in cooperation with each other. The cascade transmission processing in the terminal apparatus 20 is processing equivalent to the cascade transmission processing in the access point 10.

### 1.1.3.3 Functional Configuration Regarding Cascade Transmission Processing

Next, a functional configuration will be described regarding the cascade transmission processing of each of access point 10 and the terminal at 20 according to the first embodiment. Each of the access point 10 and the terminal apparatus 20 functions as a transmission station when executing the cascade transmission processing. Specifically, when the access point 10 executes the cascade transmission processing, each of the wireless signal processing units 150, 160, and 170 functions as a transmission unit. When the terminal apparatus 20 executes the cascade transmission processing, each of the wireless signal processing units 250, 260, and 270 functions as a transmission unit. Hereinafter, as an example, a functional configuration will be described regarding the cascade transmission processing in the terminal apparatus 20.

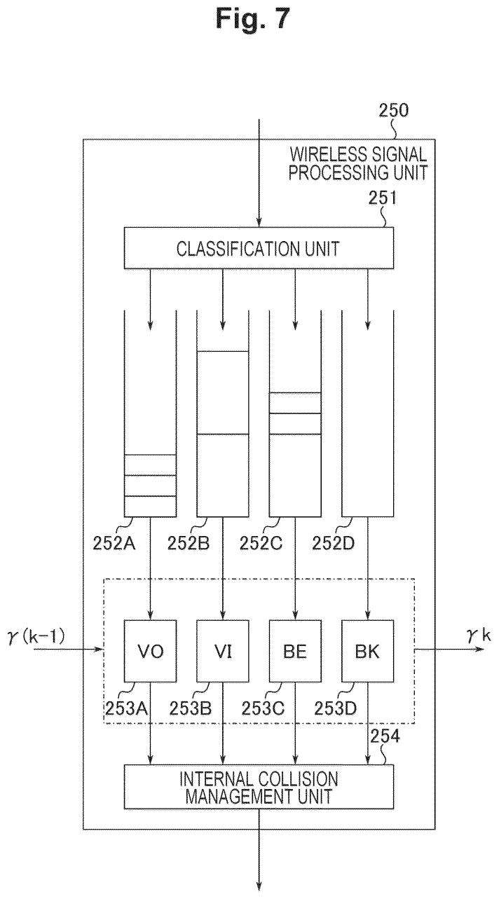

FIG. 7 is a block diagram illustrating an example of a functional configuration regarding the cascade transmission processing performed by the wireless signal processing unit according to the first embodiment. FIG. 7 illustrates an example of a functional configuration regarding the cascade transmission processing in the wireless signal processing unit 250. Note that the functional configuration regarding the cascade transmission processing in each of the wireless signal processing units 260 and 270 is equivalent to th functional configuration regarding the cascade transmission processing in the wireless signal processing unit 250, and thus the description thereof will be omitted.

The wireless signal processing unit 250 includes a classification unit 251, a plurality of queues 252A, 252B, 252C, and 252D, a plurality of carrier se units 253A, 253B, 253C, and 253D, and an internal collision management unit 254.

When the data frames divided by the fragment processing are input from the MAC frame processing unit 240, the classification unit 251 classifies the data frames into a plurality of access categories on the basis of the TID included in the MAC header. Then, the classification unit 251 inputs the data frames to corresponding queues 252 among the plurality of queues 252A, 252B, 252C, and 252D. In the example of FIG. 7, the classification unit 251 inputs data frames corresponding to the access categories VO, VI, BE, and BK to the queues 252A, 252B, 252C, and 252D.

Each of the plurality of queues 252A, 252B, 252C, and 252D buffers the input data frames. In the example of FIG. 7, the plurality of queues 252A, 252B, 252C, and 252D buffer the data frames corresponding to the access categories VO, VI, BE, and BK, respectively.

The plurality of carrier sense units 253A, 253B, 253C, and 253D correspond to the plurality of queues 252A, 252B, 252C, and 252D, respectively. Each of the plurality of carrier sense units 253A, 253B, 253C, and 253D executes carrier sense processing based on carrier sense multiple access with collision avoidance (CSMA/CA) according to an access parameter set in advance The carrier sense processing includes state determination processing of determining a state of a channel used in a link and a standby processing of waiting for redetermined time for collision avoidance. In a case where it is determined that a channel is in an idle state for a predetermined time in the carrier sense processing, each of the plurality of carrier sense units 253A, 253B, 253C, and 253D acquires a transmission right for the data frame and ends the carrier sense processing. In a case where it is determined that a channel is in a busy state, each of the plurality of carrier sense units 253A, 253B, 253C, and 253D stops acquisition of the transmission right and ends the carrier sense processing.

As the access parameter used for the carrier sense processing, for example, CWmin, CWmax, Arbitration Inter Frame Space (AIPS), and Transmission Opportunity (TXOP) Limit are used. CWmin and CWmax indicate a minimum value and a maximum value of a contention window, respectively. The contention window is a parameter used to calculate backoff that is a transmission wait time for collision avoidance. AIPS is a fixed transmission wait time set for each access category. TXOP Limit indicates an upper limit value of a channel occupancy period TXOP. That is, for the access category in which shorter CWmin, CWmax, and AIFS are set, it is easier to acquire the transmission right. In addition, for access category in which larger TXOP Limit is set, an amount of data that can be transmitted with one transmission right is larger.

Note that, the carrier sense unit 253 corresponding to the data frame subjected to the fragment processing refers to the fragment number FN in the data frame to extract the transmission order k in the cascade transmission processing of the data frame. Then, the carrier sense unit 253 determines an execution timing of the carrier sense processing regarding the data frame on the basis of the transmission order k.

Specifically, in a case where the extracted transmission order k is “1”, the unit 253 quickly executes the carrier sense processing. Then, the carrier sense unit 253 calculates a TXOP end time γ1 of the data frame and transmits the TXOP end time γ1 to the other wireless signal processing units 260 and 270.

In a case where the extracted transmission order k is not “1”, the carrier sense unit 253 waits until receiving a TXOP end time γ(k−1) of the data frame with a transmission order (k−1). When receiving the TXOP end time γ(k−1), the carrier sense unit 353 calculates a collision avoidance start time δk on the basis of the TXOP end time γ(k−1). The collision avoidance start time δk is set to be, for example, a time earlier than the TXOP end time γ(k−1) by a sum of a distributed coordination function (DCF) inter frame space (DIFS) and an average value of the backoff. The carrier sense unit 253 executes the carrier sense processing so that the standby processing can be started at the collision avoidance start time δk. Then, the carrier sense unit 253 calculates a TXOP end time γk of the kth data frame to be transmitted, and transmits the TXOP end time γk to the other wireless signal processing units 260 and 270.

In this manner, the sense processing in the corresponding wireless signal processing unit is sequentially executed according to the transmission order k. The sense unit 253 that has acquired the transmission right extracts the data frame buffered in the corresponding queue 252. The carrier sense unit 253 that has acquired the transmission right inputs the extracted data frame to the internal collision management unit 254.

The internal collision management unit 254 prevents collision of transmission in a case where two or more carrier sense units acquire the transmission right simultaneously. Specifically, for example, in a case where a plurality of data frames is simultaneously input, the internal collision management unit 254 preferentially transmits a data frame of an access category with a high priority.

### 1.2 Operation

Next, a description will be given of operation in the transmission station of the communication system according to the first embodiment.

In a case where the access point 10 is a reception station, the terminal apparatus 20 is a transmission station. In a case where the terminal apparatus 20 is a reception station, the access point 10 is a transmission station. Hereinafter, as an example, a case will be described where the terminal apparatus 20 is a transmission station. Note that, in the following description, it is assumed that the multilink ML based on the link management information illustrated in FIG. 2 is established between the access point 10 and the terminal apparatus 20.

### 1.2.1 Flowchart of Cascade Transmission Processing

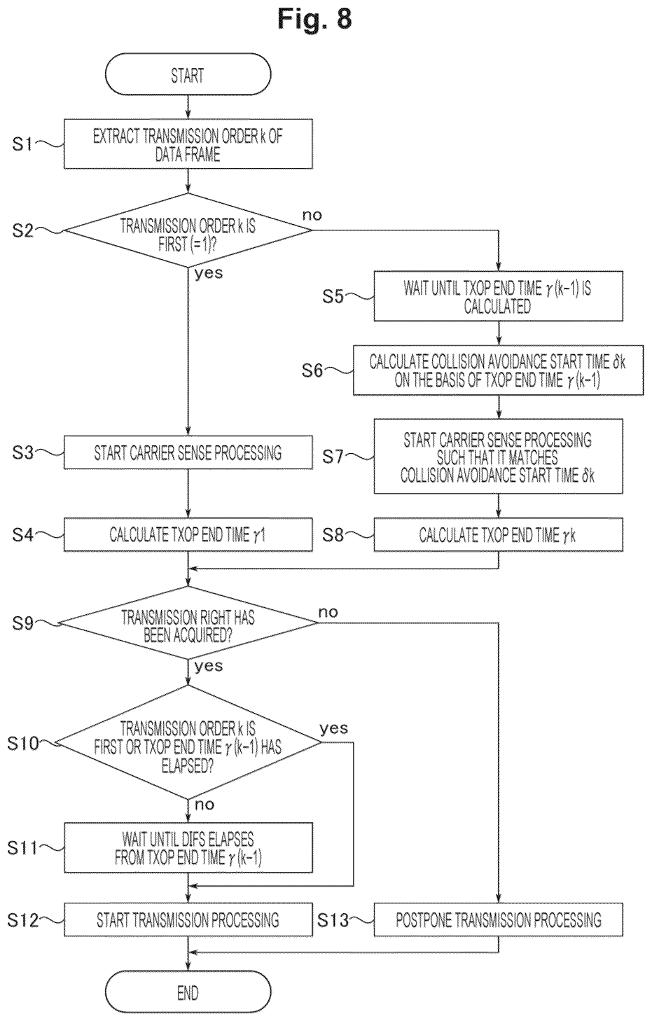

FIG. 8 is flowchart illustrating an example of the cascade transmission processing in the transmission station according to the first embodiment. Hereinafter, with reference to FIG. 8, a description will be given of processing executed by one wireless signal processing unit 250 corresponding to one STA function in the cascade transmission processing. Note that processing executed by the wireless signal processing units 260 and 270 corresponding to other STA functions in the cascade transmission processing is equivalent to the case of the wireless signal processing unit 250.

When a data frame subjected to the fragment processing is buffered in the queue 252 (start), the carrier sense unit 253 extracts the transmission order k of the data frame (S1). Specifically, for example, the carrier sense unit 253 extracts the transmission order k by referring to the fragment number FN of the data frame.

The carrier sense unit 253 determines whether or not the transmission order k extracted in the processing of S1 is the first (=1) (S2). That is, the carrier sense unit 253 determines whether or not the fragment number FN is “1”.

In a case where the transmission order k is the first (S2; yes), the carrier sense unit 253 quickly starts the carrier sense processing (S3).

When the carrier sense processing in S3 is executed, the carrier sense unit 253 calculates the TXOP end time γ1 (S4).

In a case where the transmission order k is not the first (S2; no), the carrier sense unit 253 waits until the TXOP end time γ(k−1) is calculated in the other wireless signal processing unit 260 or 270 (S5).

When the TXOP end time γ(k−1) is calculated, the carrier sense unit 253 calculates the collision avoidance start time δk on the basis of the TXOP end time γ(k−1) (S6).

The carrier sense unit 253 starts the carrier sense processing such that it matches the collision avoidance start time δk calculated in he processing of S6 (S7). That is, the carrier sense unit 253 starts the carrier sense processing so that the standby processing can be started at the collision avoidance start time δk.

When the carrier sense processing in S7 is executed, the carrier sense unit 253 calculates the TXOP end time γk (S8).

The carrier sense unit 253 determines whether or not the transmission right has been acquired by the carrier sense processing in S3 or S7 (S9).

In a case where the transmission right has been acquired (S9; yes), the carrier sense unit 253 determines whether or not the transmission order k is the first or a current time has passed the TXOP end time γ(k−1) (S10).

In a case where the transmission order k is not the first and the current time has not passed the TXOP end time γ(k−1) (S10, no), the unit 253 waits until a time when a DIFS period has elapsed from the TXOP end time γ(k−1) (S11). As a result, the carrier sense unit 253 can confirm again whether or not the data frame can be actually transmitted.

After the processing of S11, or in a case where the transmission order k is the first or the current time has passed the TXOP end time γ(k−1) (S10; yes), the wireless signal processing unit 250 starts transmission processing (S12). The transmission processing includes transmission of a data frame and reception of an acknowledgement (Ack) for the data frame.

In a case where the transmission right has not been acquired (S9; no), the wireless signal processing unit 250 postpones the transmission processing (S13).

After the processing of S12 or S13, the cascade transmission processing in the wireless signal processing unit 250 ends (end).

### 1.2.2 Example of Cascade Processing

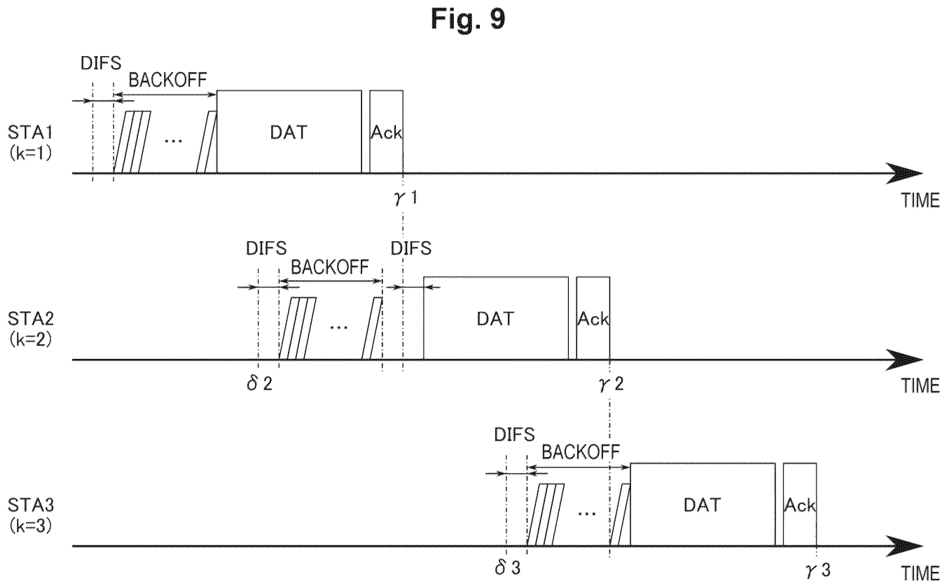

FIG. 9 a timing chart illustrating an example of the cascade transmission processing in the transmission station according to the fire embodiment. FIG. 9 illustrates a case where a data frame is transmitted first by the STA function corresponding to STA1, a data frame is transmitted second by the STA function corresponding to STA2, and a data frame is transmitted third by the STA function corresponding to STA3. Hereinafter, the STA functions corresponding to STA1, STA 2, and STA3 are simply referred to as “STA1” “STA2”, and “STA3” respectively,

STA1 extracts the first transmission order k (=1) from the input data frame. Accordingly, STA1 quickly executes the carrier sense processing. Then, STA1 calculates the TXOP end time γ1 in the carrier sense processing, and its the TXOP end time γ1 to STA2 and STA3 Thereafter, when the transmission right is acquired by the carrier sense processing, STA1 starts the transmission processing.

On the other hand, STA2 extracts the second transmission order k (=2) from the input data frame. STA3 extracts the third transmission order k (=3) from the input data frame. Accordingly, STA2 and STA3 wait until receiving TXOP end times γ1 and γ2, respectively.

When receiving the TXOP end time γ1, STA2 calculates a collision avoidance start time δ2 and starts the carrier sense processing such that it matches the collision avoidance start time δ2. As a result, STA2 can start at least the standby processing by the TXOP end time γ1. In addition, STA2 calculates the TXOP end time γ2 in the carrier sense processing, and transmits the TXOP end time γ2 to STA1 and STA3.

When acquiring the transmission right by the carrier sense processing, STA2 determines whether or not the current time has passed the TXOP end time γ1. In the example of FIG. 9, the TXOP end time γ1 has not elapsed at a time when STA2 acquires the transmission right. In this case, STA2 waits until the DIFS period from the TXOP end time γ1, thereby confirming again that no collision occurs. Then, when it is confirmed that no collision occurs, STA2 starts the transmission processing.

When receiving the TXOP end time γ2, STA3 calculates a collision avoidance start time δ3 and starts the carrier sense processing such that it matches the collision avoidance tart time δ3. Accordingly, STA3 can start at least the standby processing by the TXOP end time γ2.

When acquiring the transmission right by the carrier Sense processing, STA3 determines whether or not the current time has passed the TXOP end time γ2. In the example of FIG. 9, the TXOP end time γ2 has elapsed at a time when STA3 acquires the transmission right In this case, STA3 quickly starts the transmission processing.

When the transmission processing by STA3 ends, the cascade transmission processing ends.

### 1.3 Effects According to Fira Embodiment

According to the first embodiment, the STA function with the transmission order k starts the carrier sense processing while the STA function with the transmission order (k−1) exchanges the traffic. More specifically, the STA function with the transmission order k starts the carrier sense processing so that the collision avoidance processing can be started earlier than the TXOP end time γ(k−1) by the sum of the DIFS and the average value of the backoff. The STA function with the transmission order k for which the transmission right has bee acquired starts traffic exchange subsequent to traffic exchange of the STA function with the transmission order (k−1). As a result, the STA function with the transmission order k can acquire the transmission right after the end of the traffic exchange of the STA function with the transmission order (k−1) with a higher possibility. For this reason, it is possible to shorten a gap generated between traffic exchanges on links different from each other. Thus, deterioration of delay characteristics can be suppressed. In addition, by using a plurality of links, it is possible to distribute large-capacity data to the plurality of links. For this reason, it is possible to avoid occupying a specific link for a long period of time.

In addition, in a case where the transmission right is acquired before the TXOP end time γ(k−1), the STA function with the transmission order k waits for the start of the transmission processing until the DIFS period elapses from the TXOP end time γ(k−1). As a result, the STA function with the transmission order k can confirm again at the TXOP end time γ(k−1) whether or not collision with other traffic occurs in the link for which the transmission right has been acquired. For this reason, the collision can be more reliably avoided.

In addition, in a case where the transmission right is acquired after the TXOP end time γ(k−1), the STA function with the transmission order k quickly starts the transmission processing without additional waiting. As a result, it is possible to shorten a gap between traffic exchanges on links different from each other Thus, deterioration of delay characteristics can be suppressed.

In addition, in a case where the frame size of the data frame is greater than or equal to the threshold α, the MAC frame processing unit 240 executes the fragment processing. Through the fragment processing, the MAC frame processing unit 240 generates plurality of data frames each having a frame size smaller than the threshold α. As a result, the plurality of STA functions can execute the cascade transmission processing on the plurality of data frames having the frame size smaller than the threshold α. For this reason, it is possible to distribute large-capacity data to a plurality of links, and thus, it is possible to avoid occupying a specific link for a long period of time.

In addition, each of the plurality of data frames generated by the fragment processing includes fragment numbers FN different from each other. As a result, the STA function refers to the fragment number FN of an input data frame, thereby being able to extract the transmission order k of the data frame.

### 2. Second Embodiment

In the first embodiment, a case has been described where a transmission station includes a plurality of wireless signal processing units, so that individual links are allocated to the respective plurality of wireless signal processing units. A second embodiment is different from the first embodiment in that a transmission station includes one wireless signal processing unit, and a plurality of links is allocated to the one wireless signal processing unit. Hereinafter, a configuration and operation that are different from those of the first embodiment will be mainly described. The description of the configuration and operation equivalent to those of the first embodiment will be appropriately omitted.

### 2.1 Communication System

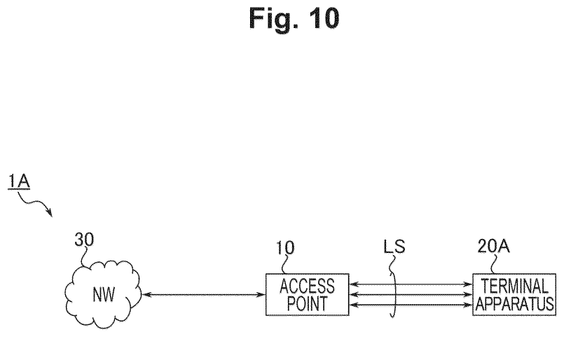

FIG. 10 is a block diagram illustrating an example of a configuration of a communication system according to the second embodiment. As illustrated in FIG. 10, a communication system 1A includes an access point 10, a terminal apparatus 20A, and a network 30.

The terminal apparatus 20A is, for example, a wireless terminal apparatus such as a smartphone or a PC. The terminal apparatus 20A is configured to communicate with a server on the network 30 via the access point 10.

In a wireless connection between the access point 10 and the terminal apparatus 20A, a link set LS including a plurality of links is established. Each of the plurality of links of the link set LS is established using the STA function provided as a functional configuration in each of the access point 10 and the terminal apparatus 20A. The access point 10 is provided a plurality of STA functions, whereas the terminal apparatus 20A is provided with one STA function.

One of the plurality of STA functions of the access point 10 and the STA function of the terminal apparatus 20A are used to establish one link. For this reason, each of the plurality of links of the link set LS is established using a corresponding one of the plurality of STA functions of the access point 10, and the STA function of the terminal apparatus 20A. Accordingly, the only one STA function provided in the terminal apparatus 20A is used to establish all the links constituting the link set LS.

### 2.2 Functional Configuration of Terminal Apparatus

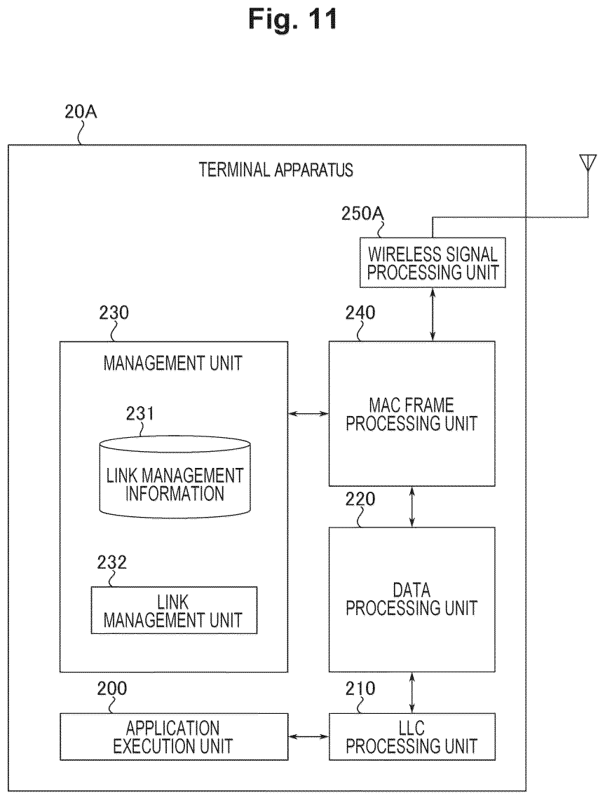

FIG. 11 is a block diagram illustrating an example of a functional configuration of the terminal apparatus according to the second embodiment. FIG. 11 corresponds to FIG. 6 in the first embodiment.

The terminal apparatus 20A functions as a computer including an application execution unit 200, an LLC processing unit 210, a data processing unit 220, a management unit 230, a MAC frame processing unit 240, and a wireless signal processing unit 250A. The configurations of the application execution unit 200, the LLC processing unit 210, the data processing unit 220, and the management unit 230 are equivalent to those in the case of FIG. 6,

The wireless signal processing unit 250A functions as any of the STA function allocated to STA1, the STA function allocated to STA2, and the STA function allocated to STA3. That is, after exchanging traffic on a certain link (for example, STA1) among the plurality of links constituting the link set LS, the wireless signal processing unit 250A can exchange traffic on other links (for example, STA2 and STA3) among the plurality of links. Note that, when a data frame is transmitted on a certain link, the wireless signal processing unit 250A cannot transmit a data frame on another link. On the other hand, the wireless signal processing unit 250A can receive the management frame described above in parallel with each other in the plurality of links of the link set LS, but may be configured to be able to receive a data frame only in any one of the plurality of links with respect to the data frame. Note that, in the plurality of links of the link set LS, frequency bands different from each other may be allocated, or different channels of the same frequency band as each other may be allocated.

Such an operation mode of the wireless signal processing unit 250A is also referred to as an enhanced multi link single radio (EMLSR) mode

When a data frame is input from the data processing unit 220, the MAC processing unit 240 determines whether or not a frame size of the data frame is greater than or equal to a threshold α. In a case where the frame size is greater than or equal to the threshold α, the MAC frame processing unit 240 performs fragment processing on the data frame to generate a plurality of data frames each having a frame size smaller than the threshold α. Then, the MAC processing unit 240 associates the generated plurality of data frames respectively with a plurality of links different from each other. Then, the MAC frame processing unit 240 sequentially inputs the plurality of data frames to the wireless signal processing unit 250A such that, for example, fragment numbers FN are in ascending order. The wireless signal processing unit 250A can regard the order of the input data frames as the transmission order.

### 2.3 Functional Configuration Regarding Cascade Transmission Processing

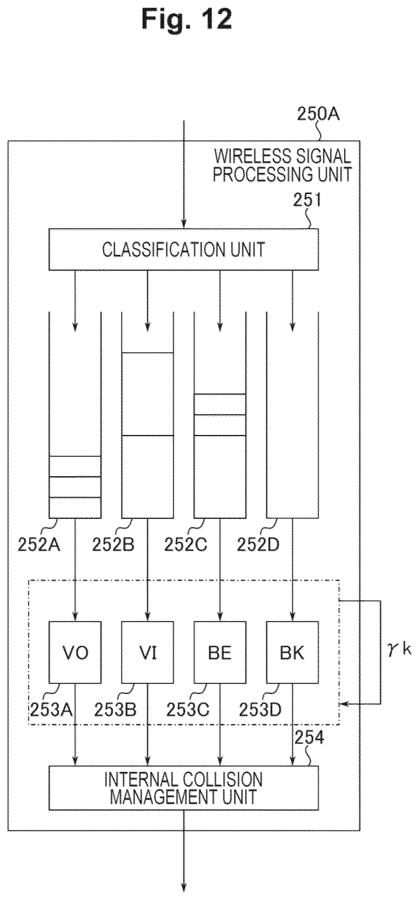

FIG. 12 is a block diagram illustrating an example of a functional configuration regarding cascade transmission processing performed by the wireless signal processing unit according to the second embodiment, FIG. 12 corresponds to FIG. 7 in the first embodiment.

The wireless signal processing unit 250A includes a classification unit 251, a plurality of queues 252A, 252B, 252C, and 252D, a plurality of carrier sense units 253A, 253B, 253C, and 253D, and an internal collision management unit 254. The configurations of the classification unit 251, the plurality of queues 252A, 252B, 252C, and 252D, and the internal collision management unit 254 are equivalent to those in the case of FIG. 7.

The carrier sense unit 253 refers to a TID in a data frame with a transmission order k to select a link corresponding to the data frame. Then, the carrier sense unit 253 determines an execution timing of carrier sense processing in the selected link.

Specifically, in a case where the transmission order k is “1”, the carrier sense unit 253 quickly executes the carrier sense processing. Then, the carrier sense unit 253 calculates a TXOP end time γ1 of the data frame.

In a case where the transmission order k is not “1”, the carrier sense unit 253 calculates a collision avoidance start time δk on the basis of a TXOP end time γ(k−1) of the data frame with a transmission order (k−1). The carrier sense unit 253 executes the carrier sense processing so that the standby processing can be started at the collision avoidance start time δk. Then, the carrier sense unit 253 calculates a TXOP end time γk of the kth transmitted data frame.

In this manner, the carrier sense processing in the wireless signal processing unit 250A is sequentially executed according to the transmission order k. The carrier sense unit 253 that has acquired the transmission right extracts the data frame buffered in the corresponding queue 252. The carrier sense unit 253 that has acquired the transmission right inputs the extracted data frame to the internal collision management unit 254.

### 2.4 Flowchart of Cascade Transmission Processing

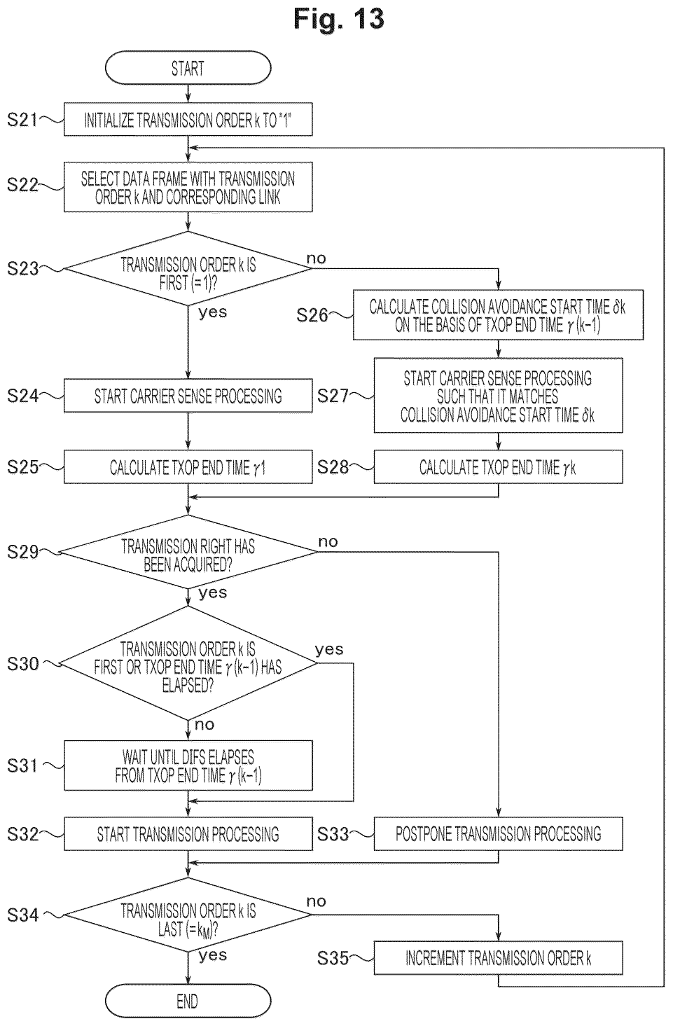

FIG. 13 is a flowchart illustrating an example of the cascade transmission processing in the transmission station according to the second embodiment. Hereinafter, with reference to FIG. 13, a description will be given of the cascade transmission processing in the wireless signal processing unit 250A operating in the EMLSR mode.

Note that, in the following description, for convenience of description, it is assumed that the data frames subjected to the fragment processing are stored in the queue 252 in the transmission order (so that the fragment numbers FN are in ascending order).

When a data frame subjected to the fragment processing is buffered in the queue 252 (start), the carrier sense unit 253 initializes the transmission order k to “1” (S21),

After the processing of S21, the carrier sense unit 253 selects the data frame with the transmission order k and the corresponding link (S22). That is, after the processing of S21 and S22, the wireless signal processing unit 250A functions as the STA function associated with the link corresponding the data frame with the first transmission order k (=1).

After the processing of S22, the carrier sense unit 253 determines whether or not the transmission order k is the first (=1) (S23).

In a case where the transmission order k is the first (S23; yes), the carrier sense unit 253 quickly starts the carrier sense processing (S24).

When the carrier sense processing is executed in S24, the carrier sense unit 253 calculates the TXOP end time γ1 (S25).

In a case where the transmission order k is not the first (S23; no), the carrier sense unit 253 calculates the collision avoidance start time δk on the basis of the TXOP end time γ(k−1) (S26).

The carrier sense unit 253 starts the carrier sense processing such that it matches the collision avoidance start time δk calculated in the processing of S26 (S27).

When the carrier sense processing is executed in S27, the carrier sense unit 253 calculates the TXOP end time γk (S28).

The carrier sense unit 253 determines whether or not the transmission right has been acquired by the carrier sense processing in S24 or S27 (S29).

In a case where the transmission right has been acquired (S29; yes), the carrier sense unit 253 determines whether or not the transmission order is the first or a current time has passed the TXOP end time γ(k−1) (S30).

In a case where the transmission order k is not the first and the current time has not passed TXOP end time γ(k−1) (S30; no), the carrier unit 253 waits until a time when a DIFS period has elapsed from the TXOP end time γ(k−1) (S31).

After the processing of S31, or in a case where the transmission order k is the first or the current time has passed the TXOP end time γ(k−1) (S30; yes); the wireless signal processing unit 250A starts transmission processing (S32).

In a case where the transmission right has not been acquired (S29; no), the wireless signal processing unit 250A postpones the transmission processing (S33).

After the processing of S32 or S33, the carrier sense unit 253 determines whether or not the transmission order k is the last (=kₘ) (S34),

In a case where the transmission order k is not the last (S34; no), the carrier sense unit 253 increments the transmission order k (S35).

Then, the carrier sense unit 253 selects the data frame with the transmission order k incremented by the processing of S35 and the corresponding link (S22). That is, after the processing of S35, the wireless signal processing unit 250A functions as the STA function associated with the link corresponding to the data frame with the next transmission order. After the processing of S22, subsequent processing of S23 to S34 is executed. In this manner, the processing of S22 to S35 is executed while incrementing the transmission order in the processing of S35 until the transmission order k becomes the last.

In a case where the transmission order k is the last (S34; yes), the cascade transmission processing in the wireless signal processing unit 250A ends (end).

### 2.5 Example of Cascade Transmission Processing

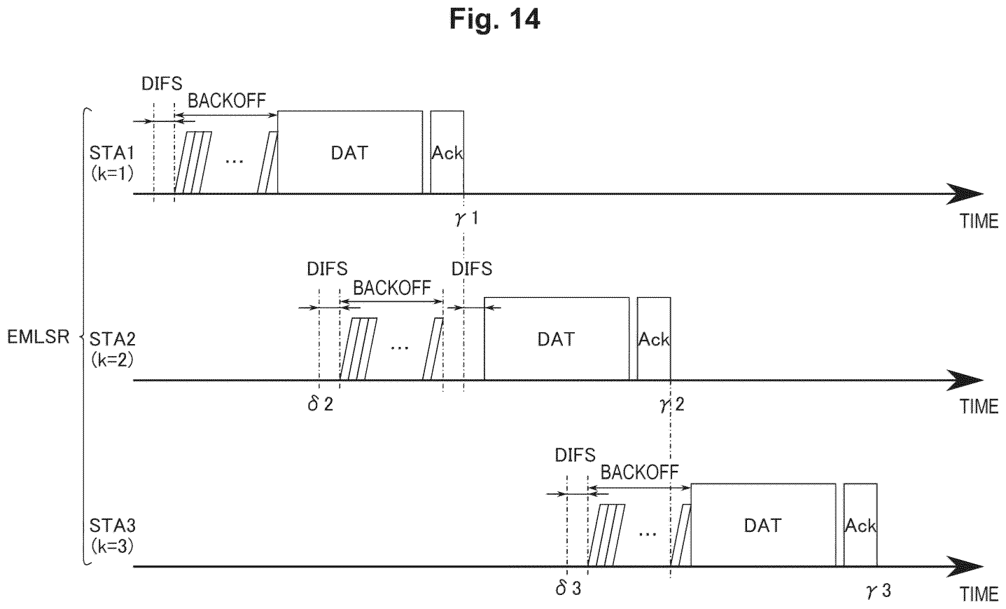

FIG. 14 is a timing chart illustrating an example of the cascade transmission processing in the transmission station according to the second embodiment. FIG. 14 corresponds to FIG. 9 in the first embodiment. FIG. 14 illustrates a case where the STA functions in the EMLSR mode corresponding to STA1, STA2, and STA3 transmit data frames first, second, and third respectively. Hereinafter, the STA functions in th EMLSR mode corresponding to STA1, STA2, and STA3 are simply referred to as STA1, STA2, and STA3, respectively

The wireless signal processing unit 250A selects STA1 on the basis of a TID of a data frame to be transmitted first. STA1 quickly executes the carrier sense processing regarding the data frame to be transmitted first. Then, STA1 calculates the TXOP end time γ1 in the carrier sense processing. Thereafter, when the transmission right is acquired by the carrier sense processing, STA1 starts the transmission processing.

Next, the wireless signal processing unit 250A selects STA2 on the basis of a TID of a data frame to be transmitted second. STA2 calculates a collision avoidance start time δ2 on the basis of the TXOP end time γ1, and starts the carrier sense processing such that it matches the collision avoidance start time δ2. As a result, STA2 can start at least the standby processing by the TXOP end time γ1. In addition, STA2 calculates a TXOP end time γ2 in the carrier sense processing.

When acquiring the transmission right by the carrier sense processing, STA2 determines whether or not the current time has passed the TXOP end time γ1. In the example of FIG. 14, the TXOP end time γ1 has not elapsed at a time when STA2 acquires the transmission right. In this case, STA2 waits until the DIFS period elapses from the TXOP end time γ1, the confirming again that no collision occurs. Then, when it is confirmed that no collision occurs, STA2 starts the transmission processing.

Next, the wireless signal processing unit 250A selects STA3 on the basis of a TID of a data frame to be transmitted third. STA3 calculates a collision avoidance start time δ3 on the basis of the TXOP end time γ2, and starts the carrier sense processing such that it matches the collision avoidance start time δ3. Accordingly, STA3 can start at least the standby processing by the TXOP end time γ2.

When acquiring the transmission right by the carrier sense processing, STA3 determines whether or not the current time has passed the TXOP end time γ2. In the example of FIG. 14, the TXOP end time γ2 has elapsed at a time when STA3 acquires the transmission right. In this case, STA3 quickly starts the transmission processing.

When the transmission processing by STA3 ends, the cascade transmission processing ends.

### 2.6 Effects According to Second Embodiment

According to the second embodiment, in a case where operation is performed in the EMLSR mode, the STA function with the transmission order k starts the carrier sense processing while the STA function with the transmission order (k−1) exchanges the traffic. More specifically, the STA function with the transmission order k starts the carrier sense processing so that the collision avoidance processing can be started earlier than the TXOP end time γ(k−1) by the sum of the DIFS and the average value of the backoff. The STA function with the transmission order k for which the transmission right has been acquired starts traffic exchange subsequent traffic exchange of the STA function with the transmission order (k−1). As a result, the STA function with transmission order k can acquire the transmission right after the end of the traffic exchange of the STA function with the transmission order (k−1) with a higher possibility. For this reason, it is possible to shorten a gap generated between traffic exchanges on links different from each other. Thus, deterioration of delay characteristics can be suppressed. In addition, by using a plurality of links, it is possible to distribute large-capacity data to the plurality of links. For this reason, it is possible to avoid occupying a specific link for a long period of time.

In addition, in a case where the transmission right is acquired before the TXOP end time γ(k−1), the STA function with the transmission order k waits for the start of the transmission processing until the DIFS period elapses from the TXOP end time γ(k−1). As a result, the STA function with the transmission order k can confirm again at the TXOP end time γ(k−1) whether or not collision with other traffic occurs in the link for which the transmission right has been acquired. For this reason, the collision can be more reliably avoided.

In addition, in a case where transmission right is acquired after the TXOP end time γ(k−1), the STA function with the transmission order k quickly starts the transmission processing without additional waiting. As a result, it is possible to shorten a gap generated between traffic exchanges on links different from each other. Thus, deterioration of delay characteristics can be suppressed.

### 3. Modification and the Like

Note that the first embodiment and the second embodiment described above can be variously modified.

For example, in the second embodiment described above, a case has been described where the wireless signal processing unit 250A in the EMLSR mode can execute, while executing the transmission processing in a certain link, the standby processing by backoff in another link, but the present invention is not limited thereto. For example, the wireless signal processing unit 250A in the EMLSR mode may not be able to execute, while executing the transmission processing in a certain link, the standby processing backoff in another link.

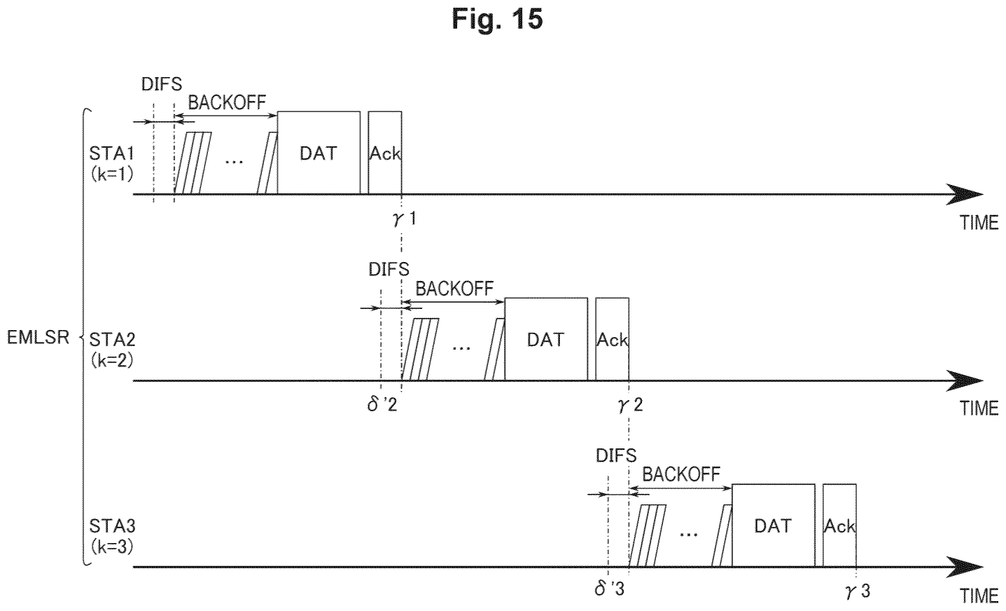

FIG. 15 is a timing chart illustrating an example of the cascade transmission processing in the transmission station according to a modification. FIG. 15 corresponds to FIG. 14 in the second embodiment.

The carrier sense unit 253 can calculate a collision avoidance start time δ′k on the basis of the TXOP end time γ(k−1). The collision avoidance start time δ′k is set to be, for example, a time earlier by the DIFS period than the TXOP end time γ(k−1). Then, the carrier sense unit 253 executes the carrier sense processing so that the standby processing can be started at the collision avoidance start time δ′k.

Operation is performed as described above, whereby it is possible to avoid, while executing the transmission processing in a certain link, overlapping execution of the standby processing by backoff in another link. Even in this case, before the transmission processing on the kth data frame ends, the carrier sense processing on another link for the (k+1)th data frame can be executed. For this reason, it is possible to increase a possibility of being able to acquire the transmission right of the (k+1)th data frame, and it is possible to suppress deterioration of delay characteristics.

In addition, for example, in the first embodiment and the second embodiment described above, a case has been described where the cascade transmission processing is applied to a plurality of data frame generated by the fragment processing, but the present invention is not limited thereto. For example, the cascade transmission processing may be applied to a plurality of data frames generated by aggregation processing.

More specifically, for example, when the aggregation processing is executed on a plurality of MAC service data units (MSDUs) or MAC protocol data units (MPDUs), a frame size of an aggregated data frame is limited to be less than a threshold β. The threshold β is a positive real number. As a result, the MAC frame processing units 140 and 240 can divide one large-capacity data frame into a plurality of data frame each having a frame size less than the threshold β. By transmitting the plurality of data frames less than the threshold β by the cascade transmission processing, it is possible to shorten a period in which a specific link is occupied as compared with a case where one large-capacity data frame is transmitted. For this reason, it is possible to obtain effects equivalent to those of the second embodiment.

Note that the plurality of data frames generated by the aggregation processing include a sequence number SN. As a result, the STA function further refers to the sequence number SN, thereby being able to extract the transmission order k of the input data frame.

In addition, the cascade transmission processing according to the first embodiment and the second embodiment described above can be stored as a program that can be executed by a processor that is a computer. In addition, it can be distributed by being stored in storage medium of an external storage device such as a magnetic disk, an optical disc, or a semiconductor memory. Then, the processor reads the program stored in the storage medium of the external storage device, and the operation is controlled by the read program, whereby the cascade transmission processing can be executed.

Note that the present invention is not limited to the embodiments described above and various modifications can be made in the implementation stage without departing from the gist of the invention In addition, the embodiments may be implemented in appropriate combination, and in this case, a combined effect can be obtained. Furthermore, the embodiments described above include various inventions, and various inventions can be extracted by a combination selected from a plurality of disclosed components. For example, even if some components are deleted from all the components described in the embodiments, a configuration from which the components have been deleted can be extracted as an invention, as long as the problem can be solved and the effects can be achieved.

### REFERENCE SIGNS LIST

1 Communication system
10 Access point
20 Terminal Apparatus
30 Network
11, 21 CPU
12, 22 ROM
13, 23 RAM
14, 24 Wireless communication module
15 Wired communication module
25 Display
26 Storage
200 Application execution unit
110, 210 LLC processing unit
120, 220 Data processing unit
130, 230 Management unit
131, 231 Link management information
132, 232 Link management unit
140, 240 MAC frame processing unit
150, 160, 170, 250, 250A, 260, 270 Wireless signal processing unit
251 Classification unit
252 Queue
253 Carrier sense unit
254 Internal collision management unit

1. A transmission station, comprising:
a first transmission circuit;
a second transmission circuit; and
a management circuit configured to establish, with a reception station, a multilink in which a first channel is allocated to the first transmission circuit and a second channel is allocated to the second transmission circuit, wherein
the first transmission circuit is configured to:
start carrier sense processing regarding first data by using the first channel during an occupancy period in which the second transmission circuit transmits second data by using the second channel; and
transmit the first data subsequent to the second data in a case where a transmission right is acquired by the carrier sense processing.

2. A transmission station, comprising:
a first transmission circuit; and
a management circuit configured to establish, with a reception station, a link set in which a first channel and a second channel are allocated to the first transmission circuit, wherein
the first transmission circuit is configured to:
start carrier sense processing regarding first data by using the first channel during an occupancy period in which second data is transmitted by using the second channel, and
transmit the first data subsequent to the second data in a case where a transmission right is acquired by the carrier sense processing.

3. The transmission station according to claim 1, wherein
the first transmission circuit is configured to wait for transmission of the first data until a predetermined period elapses after the occupancy period in a case where the transmission right is acquired during the occupancy period by the carrier sense processing.

4. The transmission station according to claim 1, wherein
the first transmission circuit is configured to start transmission of the first data without waiting in a case where the transmission right is acquired after the occupancy period by the carrier sense processing.

5. The transmission station according to claim 1, wherein
the first data includes a first fragment number, and
the second data includes a second fragment number different from the first fragment number.

6. The transmission station according to claim 1, wherein
the first data includes a first sequence number, and
the second data includes a second sequence number different from the first sequence number.

7. A transmission method for a transmission station including a first transmission circuit, a second transmission circuit, and a management circuit configured to establish, with a reception station, a multilink in which a first channel is allocated to the first transmission circuit and a second channel is allocated to the second transmission circuit, the transmission method comprising:
starting carrier sense processing regarding first data by using the first channel during an occupancy period in which the second transmission circuit transmits second data by using the second channel; and
transmitting the first data subsequent to the second data in a case where a transmission right is acquired by the carrier sense processing.

8. (canceled)

9. The transmission station according to claim 2, wherein
the first transmission circuit is configured to wait for transmission of the first data until a predetermined period elapses after the occupancy period in a case where the transmission right is acquired during the occupancy period by the carrier sense processing.

10. The transmission station according to claim 2, wherein
the first transmission circuit is configured to start transmission of the first data without waiting in a case where the transmission right is acquired after the occupancy period by the carrier sense processing.

11. The transmission station according to claim 2, wherein
the first data includes a first fragment number, and
the second data includes a second fragment number different from the first fragment number.

12. The transmission station according to claim 2, wherein
the first data includes a first sequence number, and
the second data includes a second sequence number different from the first sequence number.
